(19) United States
(12) Patent Application Publication
(10) Pub. No.: US 2004/0181604 A1
(43) Pub. Date: Sep. 16, 2004

(54) System and method for enhancing the relevance of push-based content

(76) Inventor: Pekka S. Immonen, Lepsama (FI)

Correspondence Address: CRAWFORD MAUNU PLLC, Suite 390, 1270 Northland Drive, St. Paul, MN, 55120, US

(21) Appl. No.: 10/388,190

(22) Filed: Mar. 13, 2003

(51) Int. Cl. G06F 15/16

(52) U.S. Cl. 709/232

(57) ABSTRACT

A system, apparatus and method for enhancing the relevance of information that is provided to users of communication devices. Content notifications relating to various categories/subcategories are pushed to a communication device by way of a notification service. Content usage information is received from the communication device. A modification of the set of topics targeted for transmission to the communication device occurs, where the modification is based on the content usage information of the communication device. The content notifications related to the modified topics are then pushed to the communication device via the notification service.

### FIELD OF THE INVENTION

This invention relates in general to communication of content over networks, and more particularly to a system, apparatus, and method for enhancing the relevance of information that is provided to users of communication devices.

### BACKGROUND OF THE INVENTION

While computers are still used for their traditional processing purposes, advances in communication infrastructures and protocols have turned standard computing devices into valuable communication tools. Computers communicate with each other, and with other electronic devices, over networks ranging from Local Area Networks (LANs) to wide reaching Global Area Networks (GANs) such as the Internet. Other electronic devices have experienced similar transformations, such as mobile phones, Personal Digital Assistants (PDAs), and the like. Today, these wireless devices are being used for a variety of different types of communication. For example, current and anticipated mobile phone technologies have transformed these wireless devices into powerful communication tools capable of communicating voice, data, images, video, and other multimedia content. PDAs, once the portable calendaring and organizational tool, now often include network communication capabilities such as e-mail, Internet access, etc. With the integration of wireless and landline network infrastructures, a multitude of information types can be conveniently communicated between wireless and/or landline terminals.

Traditional manners of obtaining such information include browsing for the information, where the user of the terminal utilizes a browsing application operable on the terminal. By way of the browser, the user can search or “surf” for the desired information. More particularly, in a typical client/server model, a client requests a service or information from a server, which then responds in transmitting information to the client. from the server. For example, entry of a Uniform Resource Locator (URL) at a client device which is then dispatched to the server to retrieve the associated information represents a pull transaction.

However, obtaining information in this manner can be burdensome, particularly in the case of mobile terminals where display size and user input capabilities are limited relative to their desktop counterparts. To address this situation, “push” technologies have been devised. In contrast to pull technology, push technology generally refers to a means to transmit information to one or more devices without a previous user action, such as submitting a URL to a server. Thus, there is no explicit request from the client before the server transmits its information, and push technology therefore essentially involves server-initiated transactions.

Push technology has not, however, resolved all of the problems associated with information management. The vast sources of content available via networks can result in an overwhelming amount of content being pushed to the terminal. This is particularly troublesome to the mobile terminal user. The display size of a mobile terminal simply cannot handle large amounts of text, images, etc., yet the text, images, or other indicia must be presented large enough to facilitate ease of viewing. For example, information pushed to a mobile terminal from multiple content servers (which includes any type of content source) may be so voluminous that the information actually of interest to the user rarely presents itself. Further, depending on the particular context in which the user is operating the terminal, the pushed information may be entirely inappropriate, further decreasing any benefits of receiving information via push technologies.

Accordingly, there is a need in the communications industry for a manner of providing relevant information to terminal users, while minimizing tedious management efforts required of the users. The present invention fulfills these and other needs, and offers other advantages over the prior art information management approaches.

### SUMMARY OF THE INVENTION

To overcome limitations in the prior art described above, and to overcome other limitations that will become apparent upon reading and understanding the present specification, the present invention discloses a system, apparatus and method for enhancing the relevance of information that is provided to a users of communication devices.

In accordance with one embodiment of the invention, a method is provided for enhancing the relevance of content provided to communication devices. Content notifications relating to various categories/subcategories or “topics” are pushed to a communication device by way of a notification service. Content usage information is received from the communication device. A modification of the set of topics targeted for transmission to the communication device may occur, where such a modification is based on the content usage information of the communication device. The content notifications related to the modified topics are then pushed to the communication device via the notification service. In this manner, modified topics more in line with the user's usage history will be presented to the user, rather than a larger set of topics including those having little or no interest to the user.

In accordance with more particular embodiments of such a method, content may be received from various content sources, the content may be categorized into the topics, and topics may be rated as to their relevance. In this manner, modifying the topics targeted for the communication device involves modifying the topics based on the relevance rating of the topics.

In accordance with another particular embodiment of such a method, peer content usage information may be collected from multiple communication devices on the network. The content usage information may be compared to the peer content usage information to identify peers having similar user behaviors. In this manner, modifying the topics targeted for the communication device involves modifying the topics based on the topics deemed relevant to the peers having similar user behaviors. In another particular embodiment, the topics are modified to include new topics associated with the peers having similar user behaviors.

In accordance with another particular embodiment of such a method, modifying the topics targeted for the communication device involves modifying the topics targeted for the communication device based on attributes unrelated to the substance of the content. For example, the attributes may include days of the week, calendar days, times of the day, user location, user presence status, etc. In one embodiment, these attributes provide additional filtering based on external user behaviors (e.g., user's working hours, where the user is located, etc.) that are not related to user content consumption behaviors. However, these attributes may include some aspects of user behavior related to the content consumption behaviors as well.

In accordance with another embodiment of the invention, an adaptive topic management server is provided. The adaptive topic management server is coupled to a network, and serves to enhance the relevance of content provided to communication devices. The adaptive topic management server includes a categorization module coupled to receive content from various content servers, and to categorize the content into a various topics. A user profile includes data identifying topic selection history of the communication device user. A personalized notification module is provided, which receives the topics from the categorization module, and the topic selection history from the user profile. The personalized notification module is configured to filter the topics based on the user's content selection history, and to push the filtered topics to the communication device.

In accordance with another embodiment of the invention, a system is provided for increasing the relevance of content distributed via a network. The system includes at least one terminal coupled to the network, one or more content servers (i.e., any content source) for supplying content consumable by the terminal, and a notification server(s). The notification server includes a categorization module to receive the content from the content servers, and to categorize the content into topics. The notification server also includes a user profile for the particular user, which includes data identifying topic selection history of the particular terminal user. The notification server further includes a personalized notification module to receive the topics from the categorization module and the topic selection history from the user profile, where the personalized notification module is configured to filter the topics based on the user's content selection history, and to push the filtered topics to the terminal via the network.

According to another embodiment of the invention, a computer-readable medium having stored instructions that are executable by a computer system for enhancing the relevance of content provided to communication devices is provided. The instructions executable by the computer system performing steps including pushing content notifications relating to various topics to a communication device via a notification service, receiving content usage information from the communication device, modifying the topics targeted for the communication device based on the content usage information of the communication device, and pushing the content notifications related to the modified topics to the communication device via the notification service.

In accordance with another embodiment of the invention, a terminal is provided for communicating over a network, and is adapted to enhance the relevance of content presented via the terminal. The terminal includes a categorization module to receive content from content servers, and to categorize the content into various topics such as categories, and in some cases sub-categories. A user profile maintained at the terminal includes data identifying topic selection history of the user of the terminal. The terminal includes a personalized notification module to receive the topics and the topic selection history, where the personalized notification module is configured to filter the topics based on the user's content selection history, and to present the filtered topics via the terminal.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described various examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating one embodiment of a representative network implementing a notification/push server(s) capable of increasing the relevance of information provided to content consumers in accordance with the present invention;

FIG. 2 is a block diagram illustrating an exemplary adaptive topic management system for increasing the relevance of information provided to content consumers in accordance with the present invention;

FIG. 3 is a block diagram generally illustrating a representative manner in which categorization may be effected;

FIG. 4 illustrates one manner in which the rating of relevance module may determine the relevance of notifications;

FIGS. 5 and 6 are flow diagrams illustrating various embodiments of a manner for enhancing the relevance of content provided to communication devices in accordance with the present invention;

FIG. 7 is a flow diagram illustrating one embodiment for adapting content based on user behavior in accordance with the present invention;

FIG. 8 is a block diagram illustrating a variety of factors used to provide adapted category/sub-category notifications in accordance with one embodiment of the present invention;

FIG. 9 is a UML (Unified Modeling Language) diagram modeling an exemplary structure for performing adaptive topic management in accordance with the present invention;

FIG. 10 is a UML diagram illustrating one embodiment of a notification component structure in accordance with the present invention;

FIG. 11 illustrates a representative computing system capable of carrying out operations in accordance with the present invention; and

FIG. 12 illustrates a terminal-based solution where all or part of the topic management functionality is implemented within the terminal.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a manner of enhancing the relevance of information that is provided or “pushed” to users of electronic communication devices. In accordance with the present invention, push-based information services provide more relevant and user-focused information to users, based at least in part on user behavior. In this manner, information from areas of higher interest to a particular user(s) is automatically pushed to the user, while areas of lower interest are suspended and/or reduced in presentation frequency. The determination of whether or not information is relevant to a particular user may be based on a variety of factors, including but not limited to any one or more of the user's initial interest designations, the category and/or sub-category(s) related to the information, whether or how long a categories/sub-category has been previously available and/or presented to the user, the importance of the information within a category/sub-category, peer information relevance determinations, and the like.

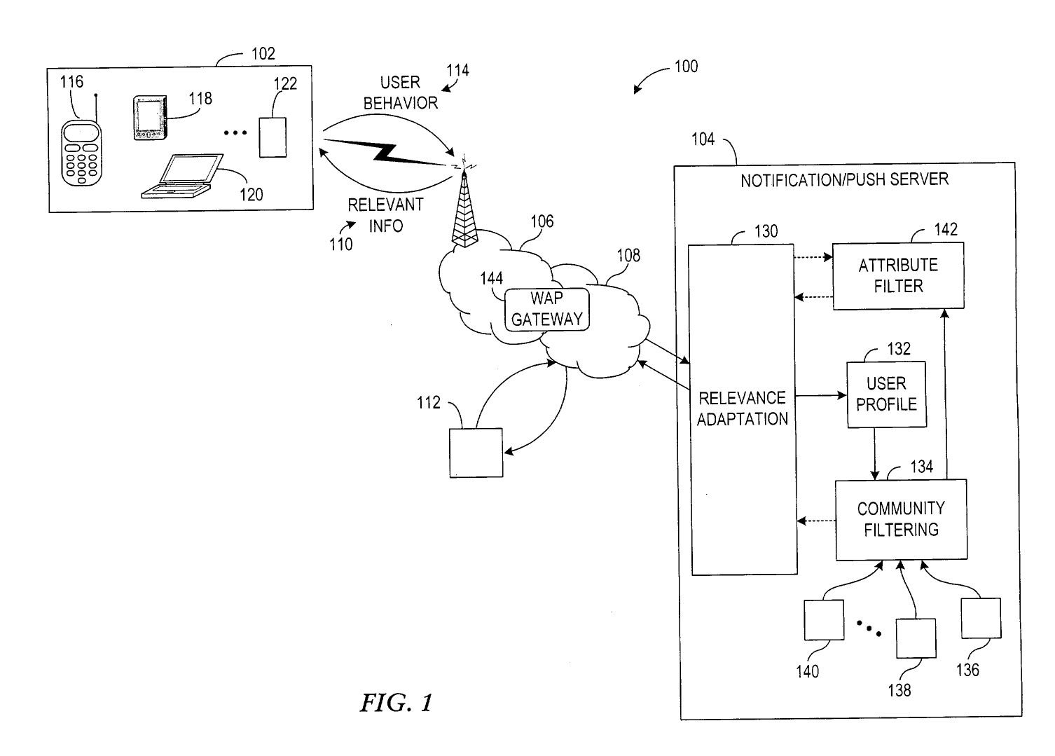

FIG. 1 is a block diagram illustrating one embodiment of a representative network 100 implementing a notification/push server(s) capable of increasing the relevance of information provided to content consumers in accordance with the present invention. For purposes of discussion, the embodiment set forth in connection with FIG. 1 is described in terms of a mobile terminal 102 and a notification/push server 104 that can communicate at least in part via a wireless network(s) 106. In the illustrated embodiment, the notification/push server 106 (hereinafter “notification server”) communicates with a network 108, which may include any one or more of a Local Area Network (LAN) or wireless LAN (WLAN), Wide Area Network (WAN), Global Area Network (GAN) such as the Internet, etc. Integration of networks 108 and wireless network 106 facilitates wireless communication between the notification server 104 and one or more mobile terminals 102. The wireless network may include Global System for Mobile Communications (GSM), Universal Mobile Telecommunications System (UMTS), Personal Communications Service (PCS), Time Division Multiple Access (TDMA), Code Division Multiple Access (CDMA), or other current or future mobile network transmission technology.

In accordance with the present invention, it is desired to provide relevant information 110 to terminals 102, 112 based at least in part on the user behavior 114 associated with the particular terminal 102, 112. For example, the notification server 104 may originally push default information and/or information initially configured by the user of the mobile terminal 102. The mobile terminal 102 may represent any wireless device, such as a mobile phone 116, Personal Digital Assistant (PDA) 118, portable computer 120, or other wireless device illustrated by generic wireless device 122. Based at least in part on user behavior 114 identified at the notification server 104, the type of information, quantity of information, etc. returned to the mobile terminal 102 can be adapted such that more relevant information 110 is available to the mobile terminal 102.

In one embodiment of the invention, the notification server includes a relevance adaptation module 130. The relevance adaptation module 130 adapts to the user behavior 114 (e.g., previous user actions) and furnishes information that the user is, or is likely to be, interested in. More particularly, the relevance adaptation module 130 in accordance with one embodiment monitors the various topic selections made by the user, and determines the categories, sub-categories, and/or information to push to the mobile terminal 102. In this manner, the information pushed to a particular user is more specific to that user's interests. This is particularly beneficial in the case of mobile terminals 102, where processing power, memory capabilities, and particularly display size may limit the ability to present a large number of information categories or topics. User-specific information may be stored in a user profile 132, where in one embodiment a different user profile exists for each of the registered users.

In accordance with another embodiment of the invention, a community filtering feature 134 is implemented, which allows for the introduction of new specific topics (e.g., categories, sub-categories, information items, etc.) to present to the user. In one embodiment, this community filtering feature 134 monitors the behavior of other, similar-minded users, which can be determined by evaluating the user profile 132 of the particular user with the user profiles 136, 138, 142 of other users. Thus, adaptation based on user behavior may result in modification (and creation, in the case of a new user) of the user profile 132. The user profile 132 provides information relating to the relevance of information categories, sub-categories, topics, etc. for that particular user. By comparing this user profile 132 to the user profiles 136, 138, 142 of other users (i.e., the “community”), it is possible to identify other users with similar interests. The information that similar-minded users are reading, viewing, hearing, etc. can then be sent to the user of the mobile terminal 102 as new information that may be of interest to the user. Using the community filtering feature 134, the newly-pushed information is therefore not based on the user's own behavior, but rather provides a way to push potentially relevant information to the user based on other criteria. In this manner, the notification server 104 provides a manner of expanding topics to areas that are potentially interesting to the user in question.

In another embodiment of the invention, the relevance adaptation module 130 works in connection with an attribute filter 142. The relevance of the pushed information can be further increased by profiling the user's behavior against various attributes such as the day of the week, the calendar date (e.g., a holiday, birthday, anniversary, etc.), time of day, location, presence status, etc. In this manner, the relevance of the pushed information can be adapted to situations where the user has different preferences in different contexts. For example, during work hours the user's interests may differ from personal time interests. As a more particular example, relevance may be weighted more heavily (or entirely) on business news during the work day, but weighted more heavily (or entirely) on entertainment news, music, or other items of personal interest at the end of the work day.

The notification/push server 104 may be implemented separately, or may be implemented together with functionality of other network elements. For example, where the end device is a mobile terminal 102, the notification server 104 may be implemented as a notification component within a Wireless Application Protocol (WAP) Gateway 144 or other proxy. More particularly, some mobile terminals 102 may interface with a landline network 108 via an element that appropriately interfaces disparate networks or protocols. A request for information may be transmitted from a WAP-compliant mobile terminal 102 in a wireless network 106 to the WAP gateway 144 that bridges the wireless 106 and landline 108 networks, and which in one embodiment also includes the notification server 104 functionality. Generally, WAP is a technology that integrates the Internet and other networks with wireless network platforms using a set of protocols that accounts for characteristics and functionality of both Internet standards and standards for wireless services. WAP thus bridges the gap between the wireline Internet paradigm and the wireless domain, to allow wireless device users to enjoy the benefits of the Internet across both platforms.

In another embodiment of the invention described more fully below, all or part of the topic management functionality associated with the notification/push server 104 may be implemented at the terminal 102, 112 itself. For example, one embodiment involves a pure terminal-based solution, where the various topic aggregation, categorization, rating, etc. occurs at the terminal. In such an embodiment, features such as the community filtering feature described above may make use of peer-to-peer networking principles to facilitate tasks such as comparing user profiles. Other embodiments may divide the topic management functionality between the terminal 102, 112 and the notification server 104. In yet another embodiment, the terminal 102, 112 may be equipped such that it is capable of operating with or without the assistance of the notification server. Such embodiments are described more fully below.

Requests for information may be transmitted from the wireless network 106 to the WAP gateway 144 (and thus to the notification server 104) by way of a Uniform Resource Locator (URL) using, for example, the Wireless Session Protocol (WSP) which is essentially a binary version of HTTP. The URL serves as the address to the requested information that is available on the network 108, such as a landline network including an intranet and/or the Internet. Viewing from the intranet/Internet side, the WAP gateway 144 receives the URL from the mobile terminal 102, and may convert the request to a protocol used on the opposite side of the WAP gateway 144 (e.g., HTTP) to access the desired information. The WAP gateway 106 may also convert content directed to the WAP-compliant terminal 102 into a format that the terminal 102 can understand, such as binary Wireless Markup Language (WML). Because the WAP gateway 144 obtains the requested information addresses from the mobile terminal 102 (and other mobile terminals), the WAP gateway 144 represents one example of a location in which the notification server 104 may be implemented. However, the notification server 104 may be implemented in other proxies, presence servers, network elements, etc., or may be implemented independently.

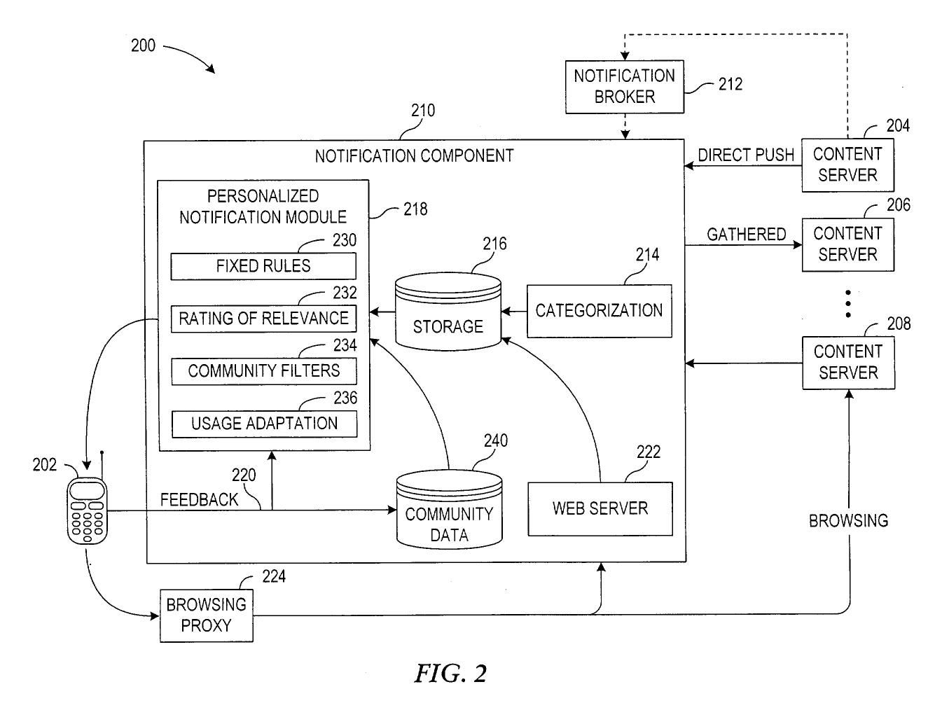

FIG. 2 is a block diagram illustrating an exemplary adaptive topic management system 200 for increasing the relevance of information provided to content consumers in accordance with the present invention. The illustrated system includes at least one mobile terminal 202, one or more information/content servers 204, 206, 208, and a notification component 210 in accordance with the present invention. The information to ultimately be provided to the mobile terminal 202 originates from any one or more available content servers 204, 206, 208. Between the content servers and the notification component 210, information may be directly pushed, as illustrated by the interface between content server 204 and the notification component 210. For example, a direct push to the notification component 210 may be used such as by way of Session Initiation Protocol (SIP), Hypertext Transfer Protocol (HTTP), Short Message Service (SMS) push, Multimedia Messaging Service (MMS) push, etc., or a Web Services Interface (WSI) push to a notification broker 212 may be effected. Alternatively (or in addition), the information may be gathered at adaptive topic management system, by requesting information from a content servers 206 via the notification component 210. For example, the latest notifications and associated content may be pulled from web servers using HTTP. In any event, the information is received at the notification component 210.

The categorization module 214 of the notification component 210 automatically categorizes the received information. In one embodiment of the invention, the categorization module 214 is implemented using software operable via a processing device(s), such as a microprocessor, microcontroller, etc. The categorization module 214 categorizes incoming notification messages based on the content in the notifications. The resulting categories may include main topics or “categories,” such as top news stories, business news, sports news, entertainment news, games, music, provisioning updates, etc. These main topics, may also have one or more levels of sub-categories. For example, sports news may have sub-categories including professional sports, amateur sports, regional/local sports, etc. Still lower level sub-categories may include soccer, basketball, baseball, etc. Such categories and sub-categories may be established in any desired manner. The creation of new sub-categories, or even new categories, may be automatic based on a new kind of content arriving to the notification component 210.

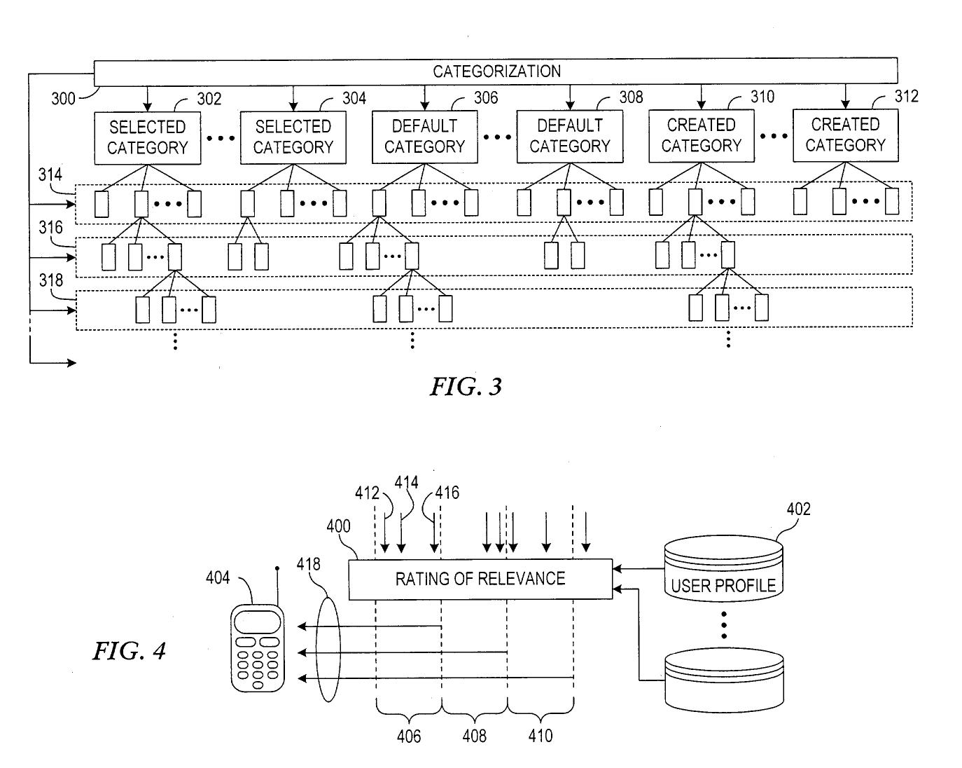

FIG. 3 is a block diagram generally illustrating a representative manner in which categorization may be effected. Associated with the categorization module 300 may be any number of selected categories 302, 304, such as those categories/sub-categories selected by the user via a client application on the terminal and/or via another configuration mechanism such as a web site where such selections may be made. Default categories 306, 308 may also exist, particularly in the case where no initial user selections of categories/sub-categories have been made. Created categories 310, 312 refer to those categories that may be created due to new categories becoming available, categories arising from community filters or usage adaptation, etc. Any of these categories may be modified via user behavior and/or community filtering (described more fully below), such that the various categories 302-312 are not necessarily static, but rather are dynamic in the sense that they can be added or removed with respect to a particular user. Further, any of these categories may have any number of sub-categories, as depicted by the decreasing levels 314, 316, 318 of sub-categories.

Returning now to FIG. 2, the categorization module 214 in accordance with one embodiment of the invention receives the notification messages, and interrogates the content to determine which of the categories/sub-categories (hereinafter “C/SC”) in which the information should be categorized. Any number of algorithms may be employed to interrogate the content in this manner, and the particular algorithm implemented is not of particular import to the present invention. For example, the categorization module 214 may analyze the content for key terms and/or phrases (e.g., “baseball,” “Academy Awards,” “United Nations,” etc.), and/or key names (e.g., actor/actress names, country leaders, country/city names, company names, etc.), and/or key events (e.g., labor strike, hurricane, etc.). Any predetermined terms, phrases, names, events, and the like may be used to determine the S/CS of the content.

Such categorizations may instead, or additionally, take into account the source of the information. For example, information provided by a content server associated with a sports agency may be immediately designated as a “sports” category, with further analysis as to the sub-category to which the particular content belongs. In such an embodiment, a source address may be included in a header or other area associated with a notification message, and the source address may be compared to a table or other list of known source addresses to assist in the categorization.

Further, a code or other indicia may be directly used with the message as an indication of the C/SC, such as information provided in a header of the notification message and/or embedded message. As a more particular example, the content source may use otherwise unused or reserved bits in a header field, an options field, or the like to encode categories and/or sub-categories to which the particular information is associated. Again, any type of predetermined categorization may be utilized in connection with the present invention.

The categorized information is then stored, as notifications, in a temporary storage 216. The stored notifications are used by the personalized notification module 218 to determine the relevance of the notifications as they pertain to particular users. For a particular user, such as the user of mobile terminal 202, feedback is provided to the personalized notification module 218 as illustrated on feedback path 220. This feedback includes indications of the particular topics deemed of interest to the user. This can be determined by, for example, recognizing the items “opened” by the user. More particularly, the user may access the information via a web server 222, or via a content server 204, 206, 208 via the browsing proxy 224, depending on the source of the content. If the user selects a particular link(s) to view or otherwise obtain access to the content associated with a presented category, sub-category, item, etc., this can be recognized as a category/sub-category that is of interest to the user of mobile terminal 202.

Therefore, in order to be able to adapt to the user behavior, the notification component 210 obtains information about the topics that the user was interested in, e.g., opened the full story associated with the presented link, heading, summary, etc. In one embodiment, this can be reported by the browsing proxy 224. In another embodiment, this can reported as feedback 220 by a client application at the mobile terminal 202. If reporting is effected from the client application in this manner, then there is no tight coupling with browsing. Further, for user interface (UI) reasons, the client application could locally hide part of the notification data, and report if the user views the complete data.

The notification component 210 supports a profile for each user. The profile will establish which categories/sub-categories are favored by the user and which are not favored. By way of these user profiles and the personalized notification module 218, the relevance of arriving notifications stored in the storage 216 can be rated. The personalized notification module 218 therefore provides a manner in which personalized notifications can be delivered to users. In one embodiment, the sending of such notifications can be configured with any one or more of fixed rules 230, rating of relevance function 232, community filters 234, and adaptation to user behavior 236.

More particularly, fixed rules 230 may be established in some cases, such that certain notifications are set based on such fixed rules. An example may involve always sending notifications of a particular category, such as a “top stories” category, or categories specifically identified by the user during an initial category configuration.

Community filters 234 may be used in connection with collected community data 240, as was described in connection with FIG. 1. In this case, the user profile of a particular user is compared against other users in the system, and users having similar preferences are identified. More particularly, the community filtering feature 234 monitors the behavior of other, similar-minded users, which can be determined by evaluating the user profile of the particular user with the user profiles of other users. Thus, adaptation based on user behavior may result in modification of the user profile. By comparing this user profile to the user profiles of other users, it is possible to identify other users with similar interests. In this manner, the notification component 210 provides a manner of expanding topics to areas that are potentially interesting to the user in question.

The usage adaptation module 236 receives the feedback 220 from the user, and can adapt the information that is to be sent to the user of the terminal 202. For example, if the user has not taken any action (e.g., selected the item to view) with respect to a category over a predetermined time or within a predetermined number of selections, the usage adaptation module 236 may decrease the frequency of notifications in this category/sub-category (C/SC), may only send notifications that are highly relevant in that C/SC, may discontinue sending of notifications in that C/SC entirely, etc. On the other hand, the usage adaptation module 236 may increase the frequency of notifications in an C/SC in which the user has taken some action in that C/SC, and/or may increase the number of notifications in that C/SC by reducing the relevance threshold for such notifications.

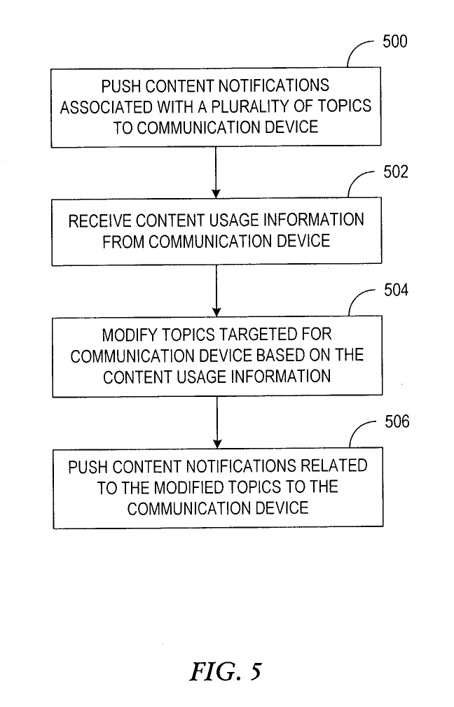

A rating of relevance module 232 may be used in connection with such a usage adaptation module 236. The rating of relevance module 232 estimates the relevance of a notification against a user's profile of preferred categories. FIG. 4 illustrates one manner in which the rating of relevance module may determine the relevance of notifications. In the illustrated embodiment of FIG. 4, the rating of relevance module 400 receives categorized notifications and/or content topics, originally provided from various sources such as content servers. The rating of relevance module 400 estimates the relevance of a notification against the user profile 402 corresponding to the user of a terminal 404. In this embodiment, rating windows 406, 408, 410, etc. are used, which represent particular windows of time in the illustrated embodiment. For example, if during rating window 406 a certain number of notifications 412, 414, 416 are received, the most relevant notifications 418 in view of the user profile 402 from the corresponding time period are sent to the terminal 404. Thus, during each rating window 406, 408, 410, the received notifications are ranked against the user's particular user profile 402. In an exemplary embodiment, the resulting rated notifications are sent to the terminal 404 as a steady flow of notifications.

The user profile 402 may change in response to the user's behavior. For example, the usage adaptation module 236 of FIG. 2 may ultimately determine that the user is no longer interested in a particular C/SC, thereby modifying the user profile 402 in FIG. 4 such that the rating of relevance module 400 will provide different notifications at different rating windows.

Returning again to FIG. 2, the resulting information is “pushed” to the terminal 202 in accordance with one embodiment of the present invention. In the terminal, the client application operates as a push/notification client, where the client receives notifications from the network. Any push technology may be used to provide the notifications to the terminal 202. In a typical client/server model, a client requests a service or information from a server, which then responds in transmitting information to the client. This is generally referred to as “pull” technology, where the client pulls the information from the server. For example, entry of a Uniform Resource Locator (URL) at a client device which is then dispatched to the server to retrieve the associated information represents a pull transaction. In contrast, a “push” feature (also known as a “notification” feature or “alert” feature) generally refers to a means to transmit information to devices without a specific user action. Thus, there is no explicit request from the client before the server transmits its information, and therefore push technology essentially includes server-initiated transactions. Push technologies can be used in connection with various protocols and communication technologies. For example, some representative push technologies include SMS, MMS, WAP push, SIP push, as well as others. Further, in accordance with one embodiment of the present invention, a notification broker may be used to facilitating transmission of push messages from network applications to mobile terminals operating under multiple push technologies.

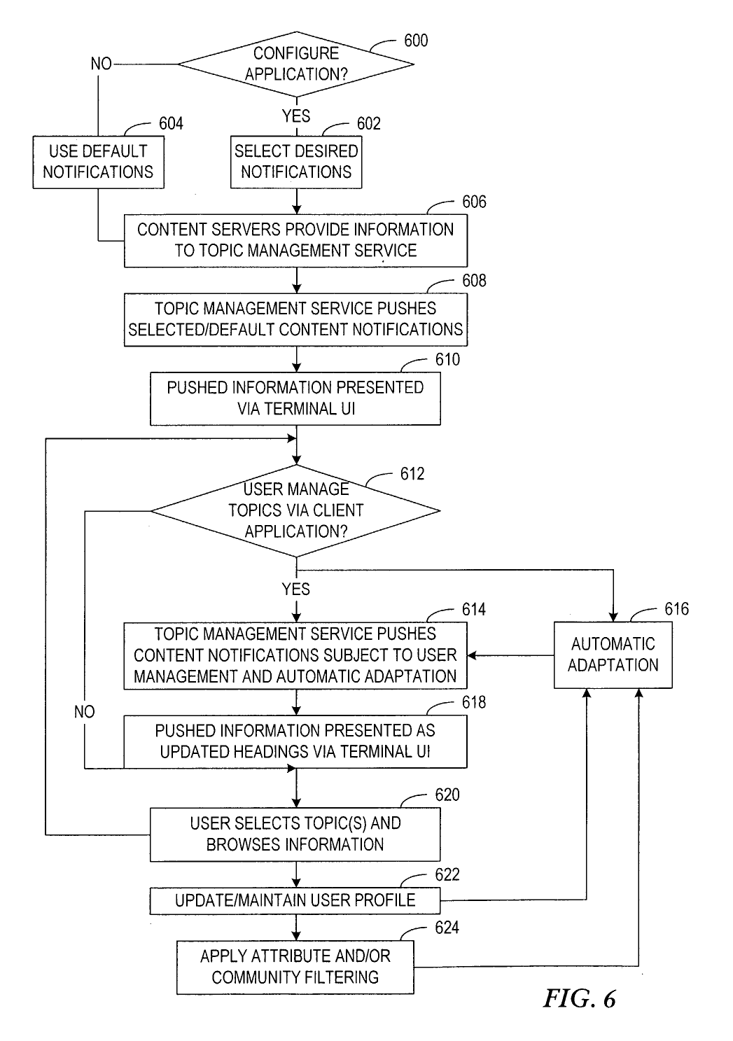

FIG. 5 is a flow diagram illustrating one embodiment of a manner for enhancing the relevance of content provided to communication devices in accordance with the present invention. Content notifications associated with various content topics are pushed to a communication device such as a mobile terminal. The content itself may be provided together with the content notification, or alternatively the notification may include a link or other address to the corresponding content. The notification may be pushed using any notification or push service known in the art.

Content usage information is received from the communication device. For example, the content usage information may represent which topics were selected by the user for reading, viewing, or other media presentation. This information thus reflects the user behavior as it pertains to the selectable topics. As previously indicated, these topics may include categories, sub-categories, and/or individual content items. Therefore, as the user selects items locally on the communication device for presentation, this content usage information is provided to the notification component in accordance with the present invention.

Based at least in part on this content usage information, the list or other group of topics that are targeted for pushing to that particular communication device are modified. For example, where the content usage information indicates a particular category(s) and/or sub-category(s) that the user has not opened or otherwise accessed, the topics to be pushed may be modified such that those particular category(s) and/or sub-category(s) are not sent at all, are sent less frequently, are sent for a predetermined number of the most relevant C/SC items, and/or are sent only for those particular C/SC items exceeding a particular relevance threshold. As an example of the latter case, the user may essentially be ignoring a category/sub-category, and the pushing of content associated with that C/SC may be suspended unless the content is deemed a “hot” topic—i.e., particularly relevant to that C/SC. If the user ignores even those hot topics, pushing of content in that C/SC may be suspended indefinitely. As another example, a fixed number (e.g., three, four, etc.) of the most relevant C/SC items may represent the C/SC items targeted for pushing to the terminal. More particularly, one embodiment of the invention involves determining the most relevant “x” number of C/SC items present at the end of a rating window, where “x” represents any desired number.

Analogously, where the content usage information indicates that the user is interested in a particular topic, then more content associated with that category/sub-category may be sent. For example, the requisite relevance of the content in such a C/SC may be lowered where the content usage information indicates a higher user interest in that C/SC. In some cases, eventually all of the content associated with that C/SC may be sent to the user.

Other modifications may also be made, based on community filtering and attribute filtering. For example, where it is determined that other users have similar interests to the user in question, then categories/sub-categories interesting to those other users may be pushed to the user in question. Attribute filtering may provide topic modification based on information unrelated to the substance of the content itself, such as time of day, calendar date, location, presence status, etc. In this manner, the relevance of the pushed information can be increased further by profiling the user's behavior against these various attributes.

With the topics being modified appropriately, these modified topics are then pushed 506 to the communication device. As previously indicated, any appropriate push technology may be used. For example, a WAP push technique may be used for WAP-compliant devices, and SIP push techniques may be used for SIP-compliant devices. In one embodiment of the invention described more fully below, the communication device subscribes via SIP signaling (i.e., SUBSCRIBE), and receives notifications via SIP signaling (i.e., NOTIFY, MESSAGE, etc.). Other push methodologies may alternatively be used. The user will receive the modified content notifications, and the process can repeat in that the content usage information relating to these modified content notifications may again change, thereby resulting in additional modifications to the topics targeted for the communication device.

FIG. 6 is a flow diagram illustrating another embodiment of a manner for enhancing the relevance of content provided to communication devices in accordance with the present invention. If the user chooses to configure the application as determined at decision block 600, the user selects 602 the desired notifications. For example, via a web site and/or via the client application on the terminal, the user can designate desired news categories and sub-categories, newsletters, etc. If the user chooses not to make such selections, default notifications 602 may be initially used. As shown at block 606, the appropriate content servers provide various types of content to the notification component, referred to in FIG. 6 as the topic management service. The topic management service pushes 608 the content notifications to the users based on their respective preferences (and ultimately on the user behavior). The pushed information is presented 610 to the user via the terminal, such as via the display on the terminal and/or other user interface mechanisms such as audio.

The user may choose to manage at least some of the topics via a client application operating on the terminal. For example, the user may remove any one or more of the notification categories/sub-categories directly via the client application, such as by highlighting the topic and executing a delete function. If the user manages topics via the client application as determined at decision block 612, the topic management service pushes 614 the content notifications subject to the user management operations, and subject to automatic adaptation 616 described more fully below. The pushed information is presented 618 as, for example, updated headings via a terminal user interface (UI) such as a display screen.

Whether or not the user chose to manually manage topics via the client application, the user can select 620 topics and browse the corresponding information. For example, where the topics are provided as category/sub-category links, the user can move a terminal cursor, speak a voice command, press an item via a touch screen, or perform other user input operations to be presented with the corresponding information. In some cases the content may already have been provided and stored locally on the terminal, while in other cases selection of the topic may initiate a browser or other application to access the information. When the user makes such selections, the user profile is updated 622. In this manner, the “user behavior” is accounted for, and subsequently used as part of the automatic adaptation 616, which in turn determines what information will be pushed to the terminal. The user's manual management of topics may also be considered by the automatic adaptation 616. Furthermore, community filtering and/or attribute filtering may be utilized to further define the automatic adaptation 616. Therefore, the user's manual selections, user behavior affecting the user profile 622, as well as community and/or attribute filtering 624 may be used as part of the automatic adaptation 616 to determine the topics to be pushed to the terminal.

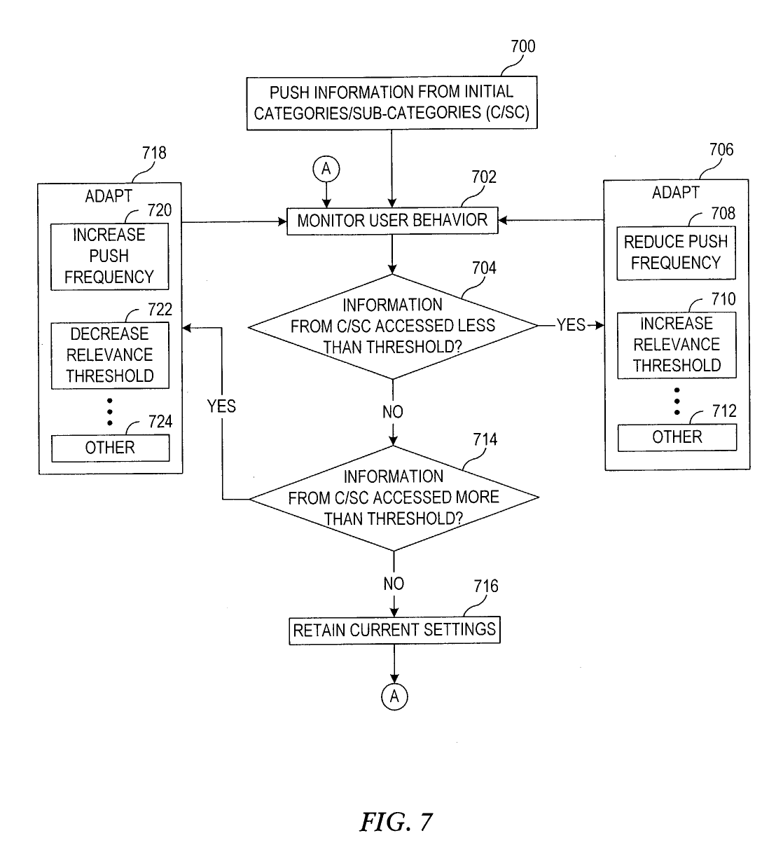

FIG. 7 is a flow diagram illustrating one embodiment for adapting content based on user behavior in accordance with the present invention. Information from initial categories/sub-categories (C/SC) is pushed 700 to the terminal. As described above, the initial C/SC may be determined by default and/or by user selection. The user behavior is then monitored 702. If, as illustrated at decision block 704, the information corresponding to a particular C/SC is accessed by the user less than a predetermined threshold, adaptation 706 is performed. The predetermined threshold may include, for example, a number of accesses in a predetermined time frame. As a more particular example, the predetermined number of accesses may be set to zero such that if a particular C/SC is not accessed by the user for a predetermined time, adaptation 706 occurs. This adaptation 706 may include reducing 708 the push frequency for that C/SC, increasing 710 the relevance threshold, or other 712 desired adaptation operation.

If it is determined that the information corresponding to the particular C/SC has not been accessed less than the predetermined threshold, it is determined 714 whether the C/SC has been accessed more than a predetermined threshold, which may or may not be the same threshold as used in decision 704. For example, a first threshold may be used in connection with decision block 704, and a second threshold may be used in connection with decision block 714. In such a case, a middle range will result in no adaptation. Alternatively, the predetermined thresholds may be the same, thereby resulting in substantially continuous adjustment of the notifications. In one embodiment of the invention, the thresholds are different, such that the current settings are retained 716 if the C/SC has not been accessed more or less than their respective thresholds.

If it is determined 714 that the information associated with the C/SC has been access more than the threshold (where the threshold may be any selected number, including once), then adaptation 718 occurs. This adaptation may include increasing 720 the push frequency of information corresponding to the C/SC, decreasing 722 the relevance threshold to push such information, or other 724 desired adaptation operation. Whether adaptation 706, 708 occurs, or whether the current settings are retained 716, user behavior continues to be monitored 702. In this manner, adaptation may continue until some categories are entirely suspended, while essentially all information from other C/SCs is provided to the terminal. Notifications associated with other C/SCs may fall somewhere else in that range.

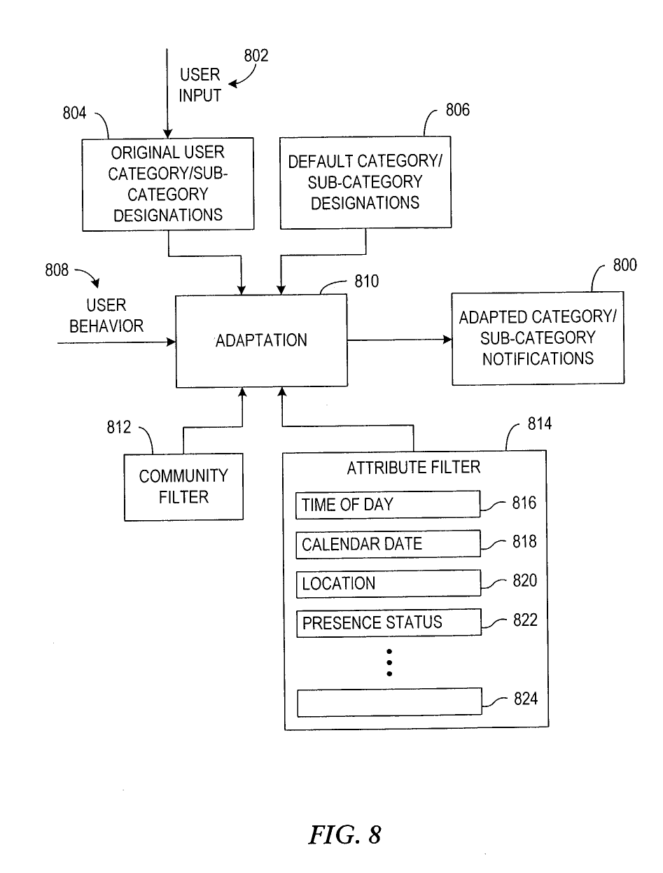

FIG. 8 is a block diagram illustrating a variety of factors used to provide adapted category/sub-category notifications 800 in accordance with one embodiment of the present invention. Via user input 802, the user may designate 804 original user categories and/or sub-categories. Default designations 806 may also be used to identify initial categories and/or sub-categories. These categories/sub-categories provide the initial C/SC notifications 800. By way of changes in user behavior 808, adaptation 810 of the notifications can be performed to provide the adapted C/SC notifications 800. In addition, a community filter 812 can be provided to the adaptation module 810 to provide the adapted C/SC notifications 800 based on similar users' preferences. The adaptation module 810 can also utilize an attribute filter 814 to provided adapted C/SC notifications 800 based on attributes unrelated to the substance of the content. For example, such attributes include time of day 816, calendar date 818, user location 820, user presence status 822 such as that used for Instant Messaging (IM) or other presence-based communication, and any other 824 desired attributes.

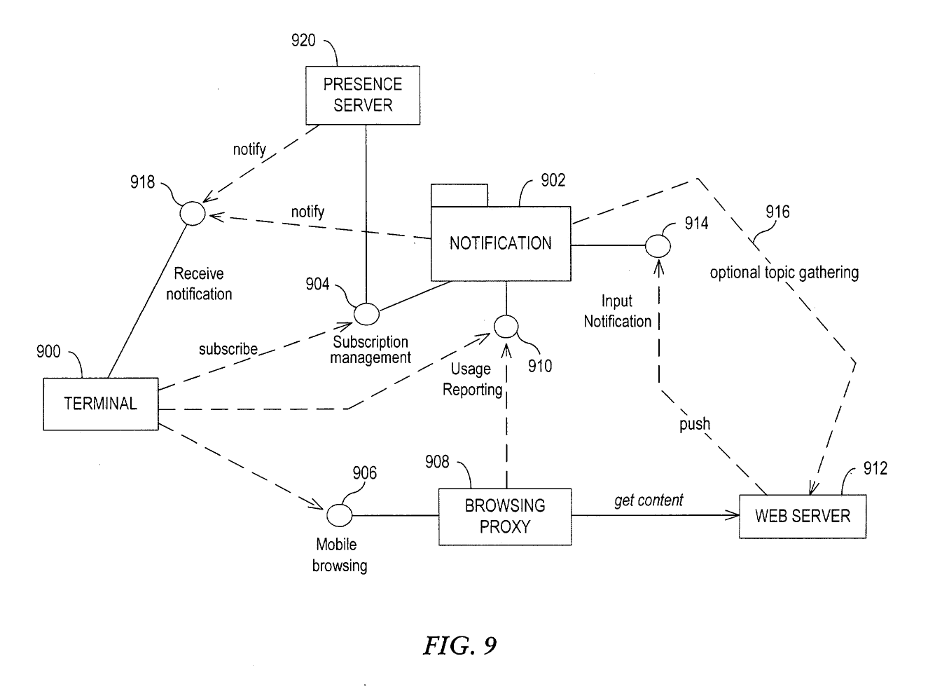

FIG. 9 is a UML (Unified Modeling Language) diagram modeling an exemplary structure for performing adaptive topic management in accordance with the present invention. A terminal 900 subscribes with the notification package 902 via the subscription management 904 interface. In one embodiment of the invention, the terminal 900 directly reports C/SC selections to the notification package 902 via the usage reporting interface 910. Alternatively mobile browsing 906 via the browsing proxy 908 can provide this reporting function to the notification package 902 via the usage reporting interface 910. The browsing proxy 908 gets content from the web server 912, which has already pushed 914 C/SC to the notification package 902 and/or provided the C/SC via topic gathering 916. The notification package 902 notifies the terminal 900 of the C/SC. A presence server 920, to which the terminal 900 may have subscribed 904, stores presence-related information for various presentities, may also provide a notification to the terminal 900 in the presence context.

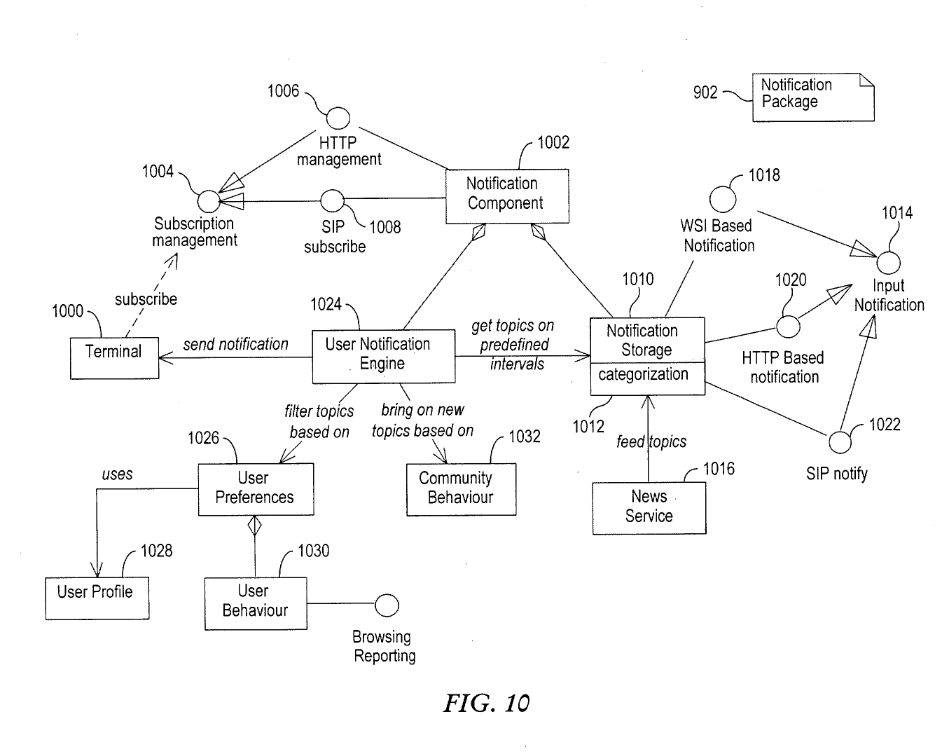

FIG. 10 is a UML diagram illustrating one embodiment of a notification component structure in accordance with the present invention. The terminal 1000 subscribes with the notification component 1002 via the subscription management 1004 interface, where the subscription management 1004 is a generalization of, for example, HTTP management 1006 and/or SIP subscribe 1008.

A notification storage class 1010 includes categorization behavior 1012 to categorize notifications received from content servers via the input notifications interface 1014 which, for example, may correspond to the input notifications interface 914 of FIG. 9. Alternatively or in addition, topics may be fed to the notification storage class 1010, such as by way of a news service 1016 which gathers (i.e., pulls) information from external web servers, thereby generally corresponding to the topic gathering 916 illustrated in FIG. 9. The input notification 1014 may represent a generalization of, for example, various specializations including Web Service Interface (WSI)-based notification 1018, HTTP-based notification 1020, and SIP notification 1022. An simple aggregation relationship between the notification storage class 1010 and the notification component class 1002 exists, as well as between the user notification engine 1024 and the notification component 1002, whereby the notification storage 1010 and the user notification engine 1024 represent non-dependent parts of the notification component 1002. The user notification engine 1024 gets topics from the notification storage 1010 at predetermined intervals in the illustrated embodiment. These topics are filtered based on user preferences 1026 which uses the user profile 1028 associated with the terminal 1000, and based on user behavior 1030. The user notification engine 1024 can also bring on new topics based on community behavior 1032 as previously described. Based on this information, the user notification engine 1024 sends a notification, such as a SIP NOTIFY, to the terminal 1000 to provide the adapted topics.

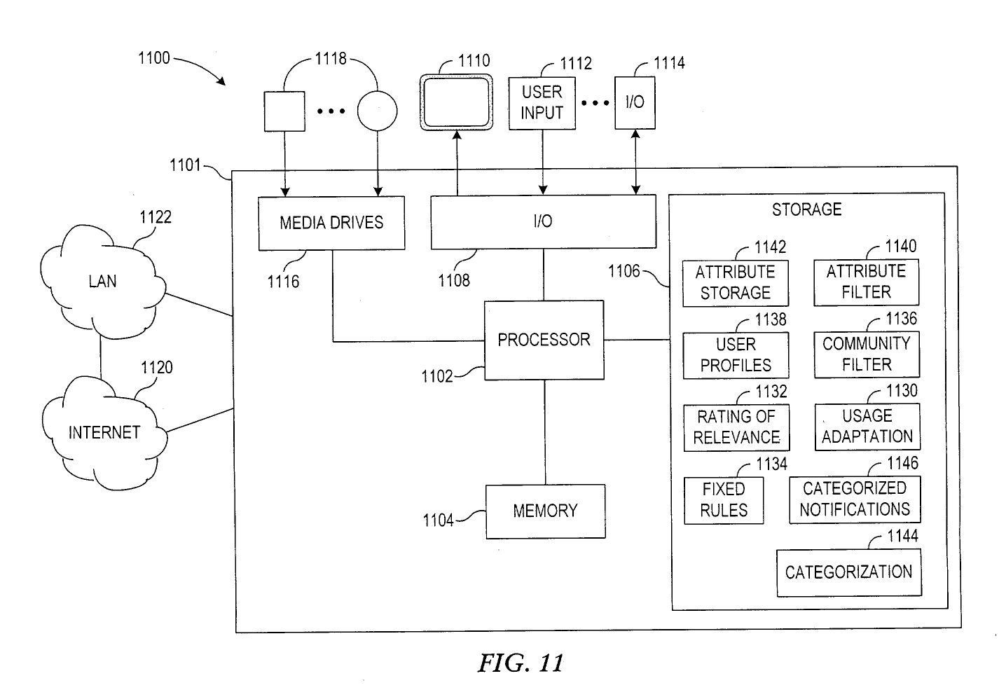

The notification servers or other systems for providing adaptive topic management in accordance with the present invention may be any type of computing device capable of performing adaptive processing and communicating notifications as described herein. The notification servers utilize computing systems to control and manage the adaptive topic management activity. Hardware, firmware, software or a combination thereof may be used to perform the various adaptation and notification functions and operations described herein. An example of a representative computing system capable of carrying out operations in accordance with the invention is illustrated in FIG. 11.

The example computing arrangement 1100 suitable for performing the adaptive topic management activity in accordance with the present invention includes a notification server 1101, which includes a central processor 1102, which may be coupled to memory 1104 and storage 1106. The processor 1102 carries out a variety of functions as is known in the art, as dictated by software and/or firmware instructions. The storage 1106 may represent firmware, hard-drive storage, etc. The storage 1106 may also represent other types of storage media to store programs, such as programmable ROM (PROM), erasable PROM (EPROM), etc. The processor 1102 may communicate with other internal and external components through input/output (I/O) circuitry 1108. The server 1101 may therefore be coupled to a display 1110, which may be any type of known display or presentation screen such as LCD displays, plasma display, cathode ray tubes (CRT), etc. A user input interface 1112 is provided, including one or more user interface mechanisms such as a mouse, keyboard, microphone, touch pad, touch screen, voice-recognition system, etc. Any other I/O devices 1114 may be coupled to the server 1101 as well.

The server 1101 may also include one or more media drive devices 1116, including hard and floppy disk drives, CD-ROM drives, DVD drives, and other hardware capable of reading and/or storing information. In one embodiment, software for carrying out the adaptive topic management operations in accordance with the present invention may be stored and distributed on CD-ROM, diskette or other form of media capable of portably storing information, as represented by media devices 1118. These storage media may be inserted into, and read by, the media drive devices 1116. Such software may also be transmitted to the presence server 1101 via data signals, such as being downloaded electronically via a network, such as the Internet 1120. The server 1101 may be coupled to other computing devices, such as the landline and/or mobile terminals, via a network. The server may be, for example, coupled to a Local Area Network (LAN) 1122 and/or may be part of a larger network configuration as in a global area network (GAN) such as the Internet 1120, which allows ultimate connection to the various landline and/or mobile client devices.

In accordance with one embodiment of the invention, the storage 1106, memory 1104, and/or media devices 1118 store the various programs and data used in connection with the present invention. In the illustrated embodiment of FIG. 11, the storage 1106 is shown storing the various programs and data. For example, the sending of notifications can be configured with various modules stored in the storage 1106, including the usage adaptation module 1130, rating of relevance module 1132, fixed rules 1134 and community filters 1136. The user profiles 1138 of the user in question, as well as the user profiles 1138 of other users for use in community filtering 1136, may be stored in the storage 1106. Similarly, an attribute filter module 1140 and associated attribute storage 1142 may be stored at the server 1101. As previously described, incoming content is categorized by categorization module 1144, providing categorized notifications 1146 that are temporarily stored. It should be recognized that these programs and data may be stored in memory or on other media rather than being stored in the storage 1106. For example, the user profiles 1138, categorized notifications 1146, and attributes 1142 may be stored in memory, while other program modules are stored in the storage 1106 or on other media 1118. The particular storage location is not relevant to the present invention.

The mobile computing arrangement 1100 of FIG. 11 is provided as a representative example of a computing environment in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

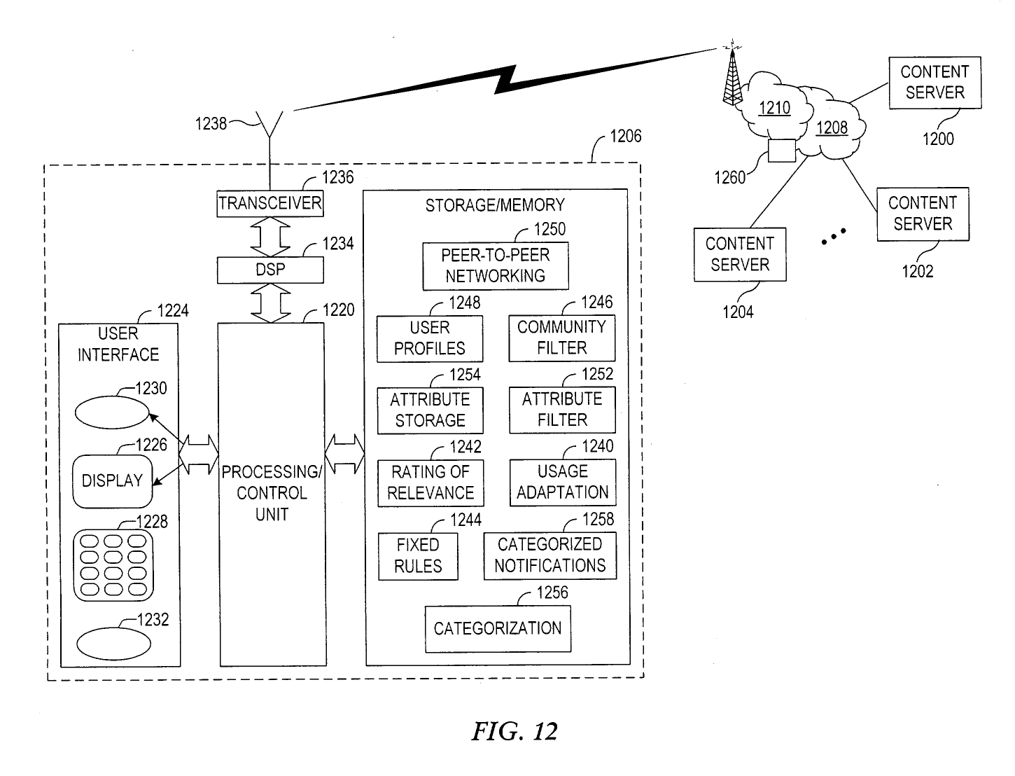

For example, all or part of the topic management functionality described herein may be implemented within the terminal itself. One such embodiment is depicted in FIG. 12, which illustrates a terminal-based solution. In this embodiment, the various topic aggregation, categorization, rating, and other functionality occurs at the terminal. In this manner, a terminal can order notifications directly from various sources without operator intervention. As shown in FIG. 12, one or more content servers 1200, 1202, 1204 may communicate with a terminal, such as a mobile terminal 1206, via landline and/or wireless networks 1208, 1210. Content may be pushed by the content servers or pulled from the content servers. In the illustrated embodiment, the terminal 1206 is depicted as a wireless terminal, such as a mobile phone, PDA, etc.

The mobile terminal 1206 utilizes computing systems to control and manage the conventional device activity as well as the functionality provided by the present invention. Hardware, firmware, software or a combination thereof may be used to perform the functions and operations described herein. The representative mobile terminal 1206 includes a computing system capable of carrying out operations in accordance with the invention. For example, the representative mobile terminal 1206 includes a processing/control unit 1220, such as a microprocessor, reduced instruction set computer (RISC), or other central processing module. The processing unit 1220 need not be a single device, and may include one or more processors. For example, the processing unit may include a master processor and associated slave processors coupled to communicate with the master processor.

The processing unit 1220 controls the basic functions of the mobile terminal 1206 as dictated by programs available in the program storage/memory 1222. The storage/memory 1222 may include an operating system and various program and data modules associated with the present invention. In one embodiment of the invention, the programs are is stored in non-volatile electrically-erasable, programmable read-only memory (EEPROM), flash ROM, etc. so that the programs are not lost upon power down networks 1208, 1210. Content may be pushed by the content servers or pulled from the content servers. In the illustrated embodiment, the terminal 1206 is depicted as a wireless terminal, such as a mobile phone, PDA, etc.

The mobile terminal 1206 utilizes computing systems to control and manage the conventional device activity as well as the functionality provided by the present invention. Hardware, firmware, software or a combination thereof may be used to perform the functions and operations described herein. The representative mobile terminal 1206 includes a computing system capable of carrying out operations in accordance with the invention. For example, the representative mobile terminal 1206 includes a processing/control unit 1220, such as a microprocessor, reduced instruction set computer (RISC), or other central processing module. The processing unit 1220 need not be a single device, and may include one or more processors. For example, the processing unit may include a master processor and associated slave processors coupled to communicate with the master processor.

The processing unit 1220 controls the basic functions of the mobile terminal 1206 as dictated by programs available in the program storage/memory 1222. The storage/memory 1222 may include an operating system and various program and data modules associated with the present invention. In one embodiment of the invention, the programs are is stored in non-volatile electrically-erasable, programmable read-only memory (EEPROM), flash ROM, etc. so that the programs are not lost upon power down of the mobile terminal. The storage 1222 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile terminal operations in accordance with the present invention may also be transmitted to the mobile terminal 1206 via data signals, such as being downloaded electronically via one or more networks, such as the Internet and an intermediate wireless network(s).

For performing other standard mobile terminal functions, the processor 1220 is also coupled to user-interface 1224 associated with the mobile terminal 1206. The recognition and processing of content from the various content servers 1200, 1202, 1204 can be implemented using various modules stored in the storage 1222, including the usage adaptation module 1240, rating of relevance module 1242, fixed rules 1244 and community filters 1246. The user profiles 1248 of the user in question, as well as the user profiles 1248 of other users for use in community filtering 1246, may be stored in the storage 1222. In such an embodiment, the community filter 1246 feature may make use of a peer-to-peer networking module 1250 that facilitates tasks such as comparing user profiles 1248. The user profiles of other peers need not be locally stored with the user profiles 1248, but rather others user profiles may be transmitted to the terminal 1206 for real-time processing.

An attribute filter module 1252 and associated attribute storage 1254 may be stored at the terminal 1206 and/or received via the network. As previously described, incoming content is categorized by categorization module 1256, providing categorized notifications 1258 that may be locally stored. It should be recognized that these programs and data may be stored in any permanent, semi-permanent, or transitory memory or storage module, or on other media such as CD-ROM, SIM, WIM, etc.

It should also be recognized that other embodiments of the invention may divide the topic management functionality between the terminal 1206 and a notification server as described in connection with, for example, FIG. 11. For example, the notification server 1260 may perform some functions, such as content filtering, while allowing direct pushing of content from the content servers 1200, 1202, 1204 and local processing when feasible. This type of embodiment may be beneficial in a pure terminal-based solution where the user may be more susceptible to unsolicited notifications. In yet another embodiment, the terminal may be equipped such that it is capable of operating either with, or without, the assistance of a notification server. For example, a notification server 1260 may provide the functions described in connection with FIG. 11, thereby allowing the terminal 1206 of FIG. 12 to locally perform such processing and/or subscribe to such functionality with the notification server 1260.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system and method in accordance with the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method for enhancing the relevance of content provided to communication devices, comprising:
pushing content notifications relating to a plurality of topics to a communication device via a notification service;
receiving content usage information from the communication device;
modifying the topics targeted for the communication device based on the content usage information of the communication device; and
pushing the content notifications related to the modified topics to the communication device via the notification service.

2. The method of claim 1, further comprising:
receiving content from one or more content sources;
categorizing the content into the topics; and
rating the relevance of the topics, wherein modifying the topics targeted for the communication device comprises modifying the topics based on the relevance rating of the topics.

3. The method of claim 2, wherein rating the relevance of the topics comprises rating a relative relevance of the topics received within a given time period.

4. The method of claim 2, wherein rating the relevance of the topics comprises comparing the topics to the content usage information to identify relevant topics as targets for the communication device.

5. The method of claim 1, further comprising:
receiving content from one or more content sources;
categorizing the content into the topics; and
comparing the content usage information to one or more fixed rules and identifying relevant topics in response thereto, wherein modifying the topics targeted for the communication device comprises modifying the topics to correspond to the relevant topics.

6. The method of claim 1, further comprising:
collecting peer content usage information from a plurality of the communication devices; and
comparing the content usage information to the peer content usage information to identify peers having similar user behaviors, wherein modifying the topics targeted for the communication device comprises modifying the topics based on the topics deemed relevant to the peers having similar user behaviors.

7. The method of claim 1, further comprising:
collecting peer content usage information from a plurality of the communication devices; and
comparing the content usage information to the peer content usage information to identify peers having similar user behaviors, wherein modifying the topics targeted for the communication device comprises modifying the topics to include one or more topics associated with the peers having similar user behaviors.

8. The method of claim 1, wherein modifying the topics targeted for the communication device comprises modifying the topics targeted for the communication device based on attributes unrelated to the substance of the content.

9. The method of claim 8, wherein the attributes comprise any one or more of days of the week, calendar days, times of the day, user location, and user presence status.

10. The method of claim 1, wherein modifying the topics targeted for the communication device comprises facilitating user modification of the topics via a client application operable on the communication device.

11. The method of claim 1, wherein modifying the topics targeted for the communication device comprises one or more of decreasing a frequency in which a topic is targeted for the communication device and increasing a requisite relevance of the topic that is targeted for the communication device, in response to the content usage information indicating a decreasing level of user interest in the topic.

12. The method of claim 1, wherein modifying the topics targeted for the communication device comprises one or more of increasing a frequency in which a topic is targeted for the communication device and decreasing a requisite relevance of the topic that is targeted for the communication device, in response to the content usage information indicating an increasing level of user interest in the topic.

13. The method of claim 1, wherein pushing content notifications relating to the topics and the modified topics comprises pushing the content notifications via wireless communications.

14. The method of claim 1, wherein pushing content notifications relating to the topics and the modified topics comprises pushing the content notifications using any one or more of a Session Initiation Protocol (SIP) push, a Hypertext Transfer Protocol (HTTP) push, a Short Message Service (SMS) push, a Multimedia Messaging Service (MMS) push, and a Web Services Interface (WSI) push.

15. The method of claim 1, wherein pushing content notifications relating to the topics and the modified topics comprises pushing the content notifications via one or more of a SIP MESSAGE and a SIP NOTIFY message to the communication devices that have subscribed to the content notifications via a SIP SUBSCRIBE message.

16. The method of claim 1, wherein pushing content notifications relating to a plurality of topics comprises pushing a notification comprising a link to content associated with the content notifications.

17. The method of claim 16, wherein receiving content usage information comprises receiving indications of user activation of the link.

18. The method of claim 1, wherein pushing content notifications relating to a plurality of topics comprises pushing the content together with the content notifications to the communication device.

19. The method of claim 1, wherein receiving content usage information comprises obtaining usage feedback directly via a client application operable in the communication device.

20. The method of claim 1, wherein receiving content usage information comprises obtaining usage feedback by way of a browsing proxy receiving links to requested content from the communication device.

21. The method of claim 1, further comprising receiving content from one or more content sources and categorizing the content into a plurality of categories, wherein any one or more of the categories may include one or more sub-categories, the categories and sub-categories representing at least some of the topics.

22. The method of claim 21, wherein categorizing the content into categories and sub-categories comprises categorizing the content based on at least one of a category/sub-category identifier and one or more keywords embedded in the content.

23. The method of claim 21, further comprising comparing the categorized content notifications to a user profile associated with the communication device, wherein the user profile reflects the content usage information from the communication device, and wherein modifying the topics comprises modifying the categorized content notifications in view of the user profile.

24. The method of claim 21, further comprising automatically creating new category/sub-category topics when a new type of content is received from the content sources.

25. The method of claim 21, wherein receiving content from one or more content sources comprises receiving the content via push technology from the one or more content sources.

26. The method of claim 21, wherein receiving content from one or more content sources comprises obtaining the content via pull technology from the one or more content sources.

27. The method of claim 1, further comprising establishing an initial plurality of topics via one or more of a default topic configuration, user selection of initial topics via a client application operable on the communication device, and user selection of initial topics via a network site.

28. An adaptive topic management server coupled to a network for enhancing the relevance of content provided to communication devices, comprising:
a categorization module coupled to receive content from one or more content servers and to categorize the content into a plurality of topics;
a user profile comprising data identifying topic selection history of a user of the communication device; and
a personalized notification module coupled to receive the plurality of topics from the categorization module and the topic selection history from the user profile, wherein the personalized notification module is configured to filter the plurality of topics based on the user's content selection history, and to push the filtered topics to the communication device.

29. The adaptive topic management server as in claim 28, further comprising a plurality of peer user profiles comprising data identifying topic selection histories of a plurality of subscribed users, wherein the personalized notification module comprises a community filter coupled to compare the user profile and at least some of the peer user profiles to identify the subscribed users having similar topic selection histories.

30. The adaptive topic management server as in claim 29, wherein the personalized notification module is further configured to push to the communication device one or more new topics associated with the subscribed users having similar topic selection histories.

31. The adaptive topic management server as in claim 28, further comprising an attribute storage module to store one or more attributes, wherein the personalized notification module comprises an attribute filter to apply the attributes to the filtered topics to further filter the topics pushed to the communication device.

32. The adaptive topic management server as in claim 28, further comprising a categorized topic storage module coupled to the categorization module to store the plurality of topics for use by the personalized notification module.

33. The adaptive topic management server as in claim 28, wherein the user profile is coupled to receive updates to the user's topic selection history.

34. The adaptive topic management server as in claim 28, wherein the adaptive topic management server comprises a processing module operable via software to implement at least the categorization module and the personalized notification module.

35. An adaptive topic management server coupled to a network for enhancing the relevance of content provided to communication devices, comprising:
means for pushing content notifications relating to a plurality of topics to at least one communication device;
means for receiving content usage information from the communication device;
means for modifying the topics targeted for the communication device based on the content usage information of the communication device; and
means for pushing the content notifications related to the modified topics to the communication device.

36. The adaptive topic management server as in claim 35, further comprising means for categorizing content received from one or more content sources into the plurality of topics.

37. The adaptive topic management server as in claim 35, further comprising:
means for collecting peer content usage information from a plurality of the communication devices; and
means for comparing the content usage information to the peer content usage information to identify peers having similar user behaviors, wherein the means for modifying the topics targeted for the communication device comprises means for modifying the topics to include one or more topics associated with the peers having similar user behaviors.

38. The adaptive topic management server as in claim 35, wherein the means for modifying the topics targeted for the communication device comprise means for modifying the topics targeted for the communication device based on attributes unrelated to the substance of the content.

39. A system for increasing the relevance of content distributed via a network, comprising:
(a) at least one terminal coupled to the network;
(b) one or more content servers for supplying content consumable by the terminal; and
(c) a notification server comprising:
(i) a categorization module coupled to receive the content from the content servers, and to categorize the content into a plurality of topics;
(ii) a user profile comprising data identifying topic selection history of a user of the terminal; and
(iii) a personalized notification module coupled to receive the plurality of topics from the categorization module and the topic selection history from the user profile, wherein the personalized notification module is configured to filter the plurality of topics based on the user's content selection history, and to push the filtered topics to the terminal via the network.

40. The system as in claim 39, further comprising a Wireless Application Protocol (WAP) gateway coupled to the network, wherein the notification server is implemented at the WAP gateway.

41. The system as in claim 39, wherein one or more of the terminals comprise wireless terminals wirelessly coupled to the network, and wherein the wireless terminals comprise one or more of a mobile phone, a Personal Digital Assistant (PDA), and a portable computer.

42. The system as in claim 39, wherein one or more of the terminals are coupled to a landline network.

43. The system as in claim 39, further comprising at least one browsing proxy coupled to the network to receive indications of selected topics from the terminal, and to update the user profile with an updated topic selection history of the user of the terminal.

44. The system as in claim 39, wherein the user profile is coupled to receive updates to the user's topic selection history.

45. A computer-readable medium having instructions stored thereon which are executable by a computer system for enhancing the relevance of content provided to communication devices by performing steps comprising:
pushing content notifications relating to a plurality of topics to a communication device via a notification service;
receiving content usage information from the communication device;
modifying the topics targeted for the communication device based on the content usage information of the communication device; and
pushing the content notifications related to the modified topics to the communication device via the notification service.

46. The computer-readable medium as in claim 45 wherein the instructions further perform steps comprising:
receiving content from one or more content sources;
categorizing the content into the topics; and
rating the relevance of the topics, wherein the instructions for performing steps for modifying the topics targeted for the communication device comprise instructions for performing steps for modifying the topics based on the relevance rating of the topics.

47. The computer-readable medium as in claim 45 wherein the instructions further perform steps comprising:
collecting peer content usage information from a plurality of the communication devices; and
comparing the content usage information to the peer content usage information to identify peers having similar user behaviors, wherein the instructions for performing steps for modifying the topics targeted for the communication device comprise instructions for performing steps for modifying the topics based on the topics deemed relevant to the peers having similar user behaviors.

48. The computer-readable- medium as in claim 45 wherein the instructions for performing steps for modifying the topics targeted for the communication device comprise instructions for performing steps for modifying the topics targeted for the communication device based on attributes unrelated to the substance of the content.

49. A terminal for communicating over a network and adapted to enhance the relevance of content presented via the terminal, comprising:
a categorization module coupled to receive content from one or more content servers and to categorize the content into a plurality of topics;
a user profile comprising data identifying topic selection history of a user of the terminal;
a personalized notification module coupled to receive the plurality of topics from the categorization module and the topic selection history from the user profile, wherein the personalized notification module is configured to filter the plurality of topics based on the user's content selection history, and to present the filtered topics via the terminal.

50. The terminal as in claim 49, further comprising a peer-to-peer networking module to facilitate receipt of a plurality of peer user profiles including data identifying topic selection histories of a plurality of other users via a peer-to-peer network, and wherein:
the personalized notification module further comprises a community filter coupled to compare the user profile and at least some of the peer user profiles to identify the users exhibiting a predetermined degree of similarity of topic selection histories; and
the personalized notification module is further configured to present via a user interface one or more new topics associated with the other users who exhibit the predetermined degree of topic selection history similarity.

51. The terminal as in claim 49, further comprising an attribute storage module to store one or more attributes, wherein the personalized notification module further comprises an attribute filter to apply the attributes to the filtered topics to further filter the topics presented via the terminal.

52. The terminal as in claim 49, wherein the terminal comprises a wireless terminal wirelessly coupled to the network to receive the content, and wherein the wireless terminal comprises any one of a mobile phone, a Personal Digital Assistant (PDA), and a portable computer.

53. The terminal as in claim 49, wherein the terminal is coupled to a landline network to receive the content.

54. The terminal as in claim 49, wherein personalized notification module is configured to modify the user profile as the topic selection history of the user changes.
